(19) United States
(12) Patent Application Publication
(10) Pub. No.: US 2024/0375269 A1
(43) Pub. Date: Nov. 14, 2024

(54) AUTOMATIC CHEMICAL DRUM REPLACEMENT APPARATUS AND CHEMICAL DRUM CONVEYANCE AND REPLACEMENT SYSTEM USING AUTOMATIC CHEMICAL DRUM REPLACEMENT APPARATUS

(71) Applicant: SAMSUNG ELECTRONICS CO., LTD., Suwon-si (KR)

(72) Inventors: Jongkyu KIM, Suwon-si (KR); Kwangjun KIM, Suwon-si (KR); Dongwon KIM, Suwon-si (KR); Minyoung KIM, Suwon-si (KR); Seounghyun SEOK, Suwon-si (KR); Jinho SO, Suwon-si (KR); Jaehwa YANG, Suwon-si (KR); Heedoo YANG, Suwon-si (KR); Hyungho CHOI, Suwon-si (KR)

(73) Assignee: SAMSUNG ELECTRONICS CO., LTD., Suwon-si (KR)

(21) Appl. No.: 18/660,985

(22) Filed: May 10, 2024

(30) Foreign Application Priority Data
May 11, 2023 (KR) 10-2023-0060982
Sep. 11, 2023 (KR) 10-2023-0120479

(51) Int. Cl. B25J 9/00; B25J 5/00; B25J 9/16; B25J 15/08; B25J 19/00; B67B 7/18

(52) U.S. Cl. CPC B25J 9/0084; B25J 5/007; B25J 9/162; B25J 9/1697; B25J 15/08; B25J 19/0083; B67B 7/182

(57) ABSTRACT

A chemical drum replacement apparatus includes an automated robotic assembly configured to attach or detach a drum cap and a coupler module to or from a chemical drum and a transfer robotic assembly configured to transfer the chemical drum, where the automated robotic assembly includes a travelling module configured to move the automated robotic assembly, a manipulator on an upper surface of the travelling module, and a gripper at an end of the manipulator, the gripper configured to attach or detach the drum cap and the coupler module to or from the chemical drum.

### CROSS-REFERENCE TO RELATED APPLICATION(S)

This application is based on and claims priority to Korean Patent Application No. 10-2023-0120479, filed on Sep. 11, 2023, in the Korean Intellectual Property Office, and Korean Patent Application No. 10-2023-0060982, filed on May 11, 2023, in the Korean Intellectual Property Office, the disclosures of which are incorporated herein by reference in their entireties.

### BACKGROUND

Example embodiments of the present disclosure relate to an automated chemical drum replacement apparatus as well as a chemical drum conveyance and replacement system using the same.

Chemical drums for supplying chemicals to a semiconductor processing line (FAB) are stored in a chemical supply apparatus, and chemicals are supplied to a process facility through a chemical pipe connected to a chemical drum.

When all chemicals in a chemical drum are exhausted and the chemical drum requires replacement, the chemical drum weighing about 200 kg to 300 kg may be replaced by a human operator, thereby applying heavy strain on the operator's musculoskeletal system and requiring a high level of attention during operation.

In addition, a chemical drum replacement operation requires an operation of fastening a cap to or separating a cap from the chemical drum, as well as an operation of fastening the chemical drum to or separating the chemical drum from a coupler module. However, due to the corrosive and toxic nature of chemicals, chemical fumes and/or chemical leakage liquids generated when the cap is separated from the chemical drum may pose a risk to the operator and a surrounding environment.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide an automated chemical drum replacement apparatus that may perform an operation of transferring and replacing a chemical drum without an operator, as well as a chemical drum conveyance and replacement system using the same.

Additional aspects will be set forth in part in the description which follows and, in part, will be apparent from the description, or may be learned by practice of the presented embodiments.

According to an aspect of an example embodiment, a chemical drum replacement apparatus may include an automated robotic assembly configured to attach or detach a drum cap and a coupler module to or from a chemical drum and a transfer robotic assembly configured to transfer the chemical drum, where the automated robotic assembly includes a travelling module configured to move the automated robotic assembly, a manipulator on an upper surface of the travelling module, and a gripper at an end of the manipulator, the gripper configured to attach or detach the drum cap and the coupler module to or from the chemical drum.

According to an aspect of an example embodiment, a chemical drum conveyance and replacement system may include at least one chemical drum replacement apparatus including an automated robotic assembly configured to attach or detach a drum cap and a coupler module to or from a chemical drum, and a transfer robotic assembly configured to transfer the chemical drum, and a manufacturing execution system connected to the at least one chemical drum replacement apparatus, where the automated robotic assembly includes a travelling module configured to move the automated robotic assembly, a manipulator on an upper surface of the travelling module, and a gripper at an end of the manipulator, the gripper configured to attach or detach the drum cap and the coupler module to or from the chemical drum.

According to an aspect of an example embodiment, a chemical drum conveyance and replacement system may include a plurality of chemical drum replacement apparatuses, each of the plurality of chemical drum replacement apparatuses including an automated robotic assembly configured to attach or detach a drum cap and a coupler module to or from a chemical drum and a transfer robotic assembly configured to transfer the chemical drum, a manufacturing control system (MCS) configured to monitor a state of a chemical supply apparatus, and a robot control system (RCS) configured to select a chemical drum replacement apparatus of the plurality of chemical drum replacement apparatuses to perform a chemical drum replacement operation and control the selected chemical drum replacement apparatus to perform the chemical drum replacement operation.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a diagram illustrating a drum conveyance and fastening system including an automated chemical drum replacement apparatus according to an example embodiment;

FIG. 2 is a perspective view of an automated robotic assembly of an automated chemical drum replacement apparatus according to an example embodiment;

FIG. 3 is a perspective view of a gripper of an automated chemical drum replacement apparatus according to an example embodiment;

FIG. 4 is a perspective view of a cap module for attachment or detachment of a drum cap according to an example embodiment;

FIG. 5 is a diagram illustrating a state in which a cap module is gripped by a gripper of an automated chemical drum replacement apparatus according to an example embodiment;

FIG. 6 is a perspective view of a coupler module installed on a chemical drum according to an example embodiment;

FIG. 7 is a diagram illustrating a state in which a coupler module is gripped by a gripper of an automated chemical drum replacement apparatus according to an example embodiment;

FIG. 8 is a diagram illustrating a state in which a first protective member is installed on a gripper of an automated chemical drum replacement apparatus according to an example embodiment;

FIG. 9 is a diagram illustrating a state in which a second protective member is installed on a manipulator of an automated chemical drum replacement apparatus according to an example embodiment;

FIG. 10 is a perspective view of an automated chemical drum replacement apparatus according to an example embodiment;

FIG. 11 is a diagram illustrating a gripper and a drum cap according to an example embodiment; and

FIG. 12 is a diagram illustrating a gripper and a coupler module according to an example embodiment.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

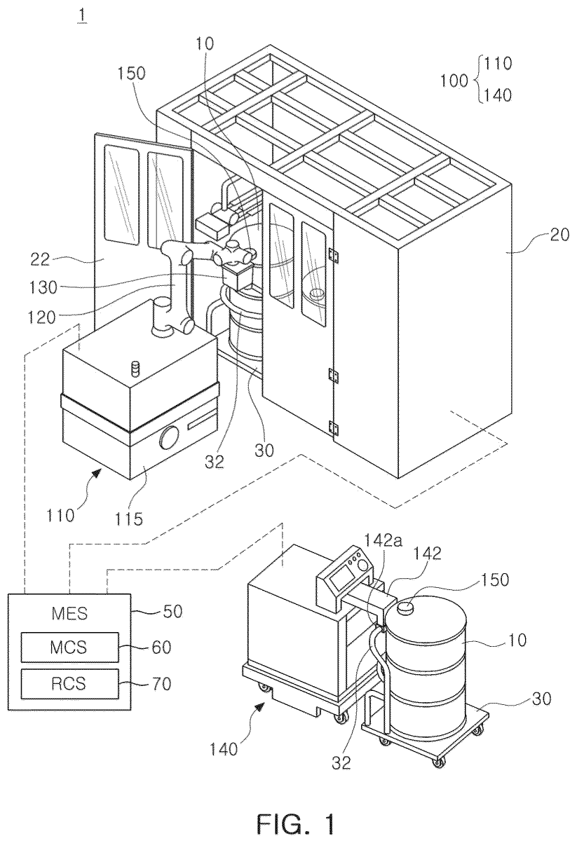

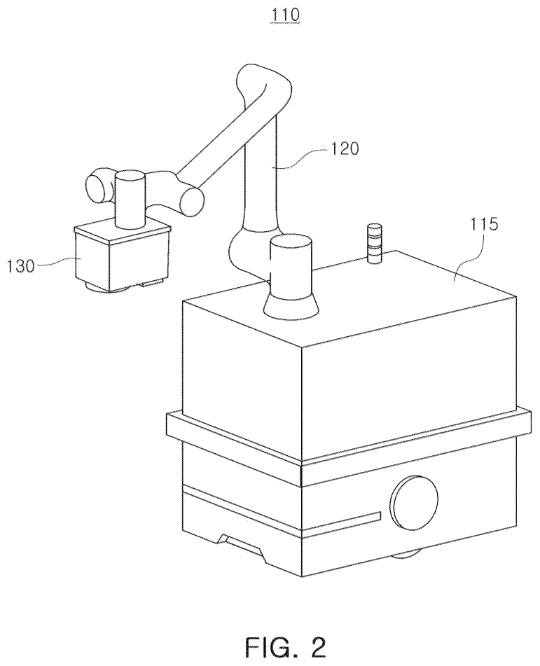

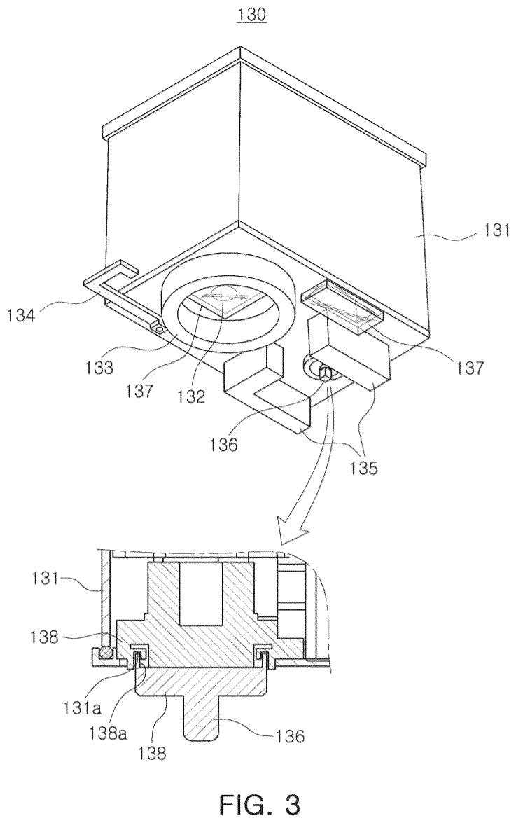

FIG. 1 is a diagram illustrating a drum conveyance and fastening system including an automated chemical drum replacement apparatus according to an example embodiment. FIG. 2 is a perspective view of an automated robotic assembly of an automated chemical drum replacement apparatus according to an example embodiment. FIG. 3 is a perspective view of a gripper of an automated chemical drum replacement apparatus according to an example embodiment.

Referring to FIGS. 1 to 3, a drum conveyance and fastening system 1 may include a manufacturing execution system 50 and an automated chemical drum replacement apparatus 100.

The manufacturing execution system 50 may include a manufacturing control system (MCS) 60 monitoring a state of a chemical supply apparatus 20 and managing drum logistics, and a robot control system (RCS) 70 selecting an automated chemical drum replacement apparatus 100 to perform an operation of replacing a chemical drum 10 and instructing the operation. The manufacturing execution system 50 may be connected to a specific facility to receive a signal indicating that chemical supply has ended. The MCS 60 may determine a chemical supply facility on which the operation of replacing the chemical drum 10 is preferentially to be performed, using an algorithm through the RCS 70, based on supply importance and supply frequency for each chemical supply apparatus 20. In addition, the manufacturing execution system 50 may determine information about the chemical drum 10 stored in a logistics warehouse through a logistics management system.

The automated chemical drum replacement apparatus 100 according to an example embodiment may include an automated robotic assembly 110 and a transfer robotic assembly 140. As described herein, the automated chemical drum replacement apparatus 100 and the transfer robotic assembly 140 may be configured to be automated, may be configured to be manually controlled, and may be configured to be operated with a combination of automated and manual control.

The automated robotic assembly 110 may include a travelling module 115, a manipulator 120, and a gripper 130. When the transfer robotic assembly 140 transfers the chemical drum 10 to the chemical supply apparatus 20, the automated robotic assembly 110 may move to a position allowing the gripper 130 to open a door 22 of the chemical supply apparatus 20.

Thereafter, when the transfer robotic assembly 140 introduces the chemical drum 10 into the chemical supply apparatus 20, the automated robotic assembly 110 may move to a position allowing the gripper 130 to attach or detach a drum cap 150 and a coupler module 160 to each other or from each other. To this end, the travelling module 115 may include a sensor and to sense a surrounding environment and an obstacle by itself and a driver to enable automated travelling (i.e., enable automated movement of the automated robotic assembly 100).

The manipulator 120 may be installed on the travelling module 115. As an example, the manipulator 120 may have six degrees of freedom. The gripper 130 may be installed at an end of the manipulator 120. In addition, operation of the manipulator 120 may move the gripper 130 to a position in which an operation is performed. The manipulator 120 may include various sensors, such as a torque sensor and a position sensor, to identify an engagement state between the drum cap 150 and the coupler module 160, and the chemical drum 10.

The gripper 130 may be installed on the manipulator 120. The gripper 130 may include a body 131 connected to the manipulator 120, a vision camera 132 disposed on a lower surface of the body 131, a vision light 133 disposed to be adjacent to the vision camera 132, a door finger 134 (e.g., a door opening and closing finger 134) disposed to be adjacent to one side of the vision light 133, gripping fingers 135 disposed on the lower surface of the body 131 to be parallel to the vision light 133, and a rotation shaft 136 disposed between the gripping fingers 135. A connector connected to the manipulator 120 may be provided on the upper surface of the body 131. As an example, the body 131 may have a rectangular box shape. The vision camera 132 may determine a position of the door 22 of the chemical supply apparatus 20 when the transfer robotic assembly 140 transfers the chemical drum 10 to the chemical supply apparatus 20. Accordingly, the manipulator 120 may operate and grip a handle of the door 22 through the door finger 134, such that the manipulator 120 may open the door 22. When the chemical drum 10 is introduced into the chemical supply apparatus 20 by the transfer robotic assembly 140, the vision camera 132 may recognize phase and position information of the drum cap 150 of the chemical drum 10. In addition, tilt information of the drum cap 150 may be recognized through a laser sensor to correct a degree of misalignment of an outlet of the chemical drum 10. The outlet may refer to a portion of the chemical drum 10 on which the drum cap 150 is mounted. As an example, the outlet may be disposed on the chemical drum 10 to tilt within a predetermined angle. A pair of gripping fingers 135 may be disposed to oppose each other, and the pair of gripping fingers 135 may be moved in an X-axis direction (FIG. 3) to be adjacent to each other or spaced apart from each other. As the gripping fingers 135 are moved in such a manner, a cap module 152 and the coupler module 160 may be gripped by the gripping fingers 135. When the rotation shaft 136 is disposed between the gripping fingers 135 and the drum cap 150 and the coupler module 160 are gripped by the gripping fingers 135, the rotation shaft 136 may rotate while being coupled to a first coupling groove 156a provided in the cap module 152 and a second coupling groove 161 provided in the coupler module 160. Accordingly, the drum cap 150 and the coupler module 160 may be attached to or detached from the chemical drum 10. A detailed description of operation of the gripper 130 will be described below.

The gripper 130 may include a transparent window 137. The transparent window 137 may serve to protect the vision camera 132 and the laser sensor from damage (e.g., corrosion) due to exposure to chemical fumes or liquids leaking from the chemical drum 10. Accordingly, damage to the vision camera 132 and the laser sensor due to exposure to chemical fumes or liquids may be prevented.

In addition, an output shaft 138 on which the protruding rotation shaft 136 is disposed may be installed on the body 131, and the output shaft 138 and the body 131 may form a labyrinth seal. As an example, the body 131 may have an installation portion 131a for installing the output shaft 138 thereon, and the installation portion 131a may have an insertion groove 131b into which an extension portion 138a of the output shaft 138 is inserted. An end of the extension portion 138a may inserted into the insertion groove 131b to form a labyrinth seal. Accordingly, chemical fumes or liquids leaking from the chemical drum 10 may be prevented from flowing into the body 131. The rotation shaft 136 may be formed integrally with the output shaft 138, or the rotation shaft 136 may be formed as a separate component.

The transfer robotic assembly 140 may serve to transfer the chemical drum 10. As an example, the transfer robotic assembly 140 may transfer the chemical drum 10, used up in the chemical supply apparatus 20, to the logistics warehouse and transfer a new chemical drum 10 from the logistics warehouse to the chemical supply apparatus 20. To this end, the transfer robotic assembly 140 may include a sensor to sense a surrounding environment and an obstacle by itself and a driver to enable automated travelling. The transfer robotic assembly 140 may include a connection member 142 having a hook portion 142a coupled to a handle portion 32 of a cart 30 on which the chemical drum 10 is mounted. As an example, the transfer robotic assembly 140 may travel in a state in which the hook portion 142a is coupled to the handle portion 32 of the cart 30, such that the chemical drum 10 loaded on the cart 30 may be transferred. As the hook portion 142a is moved by movement of the connection member 142, the hook portion 142a may be attached to or detached from the handle portion 32 of the cart 30. To this end, a driver for moving the hook portion 142a may be connected to the connection member 142.

As described above, the chemical drum 10 may be transferred by the transfer robotic assembly 140, and the door 22 of the chemical supply apparatus 20 may be opened by the gripper 130. Thereafter, the drum cap 150 and the coupler module 160 may be attached to or detached from the chemical drum 10. Accordingly, the operation of replacing, by an operator, the chemical drum 10 may not be performed.

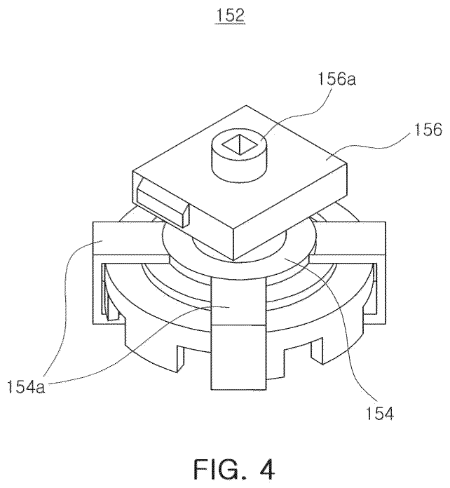

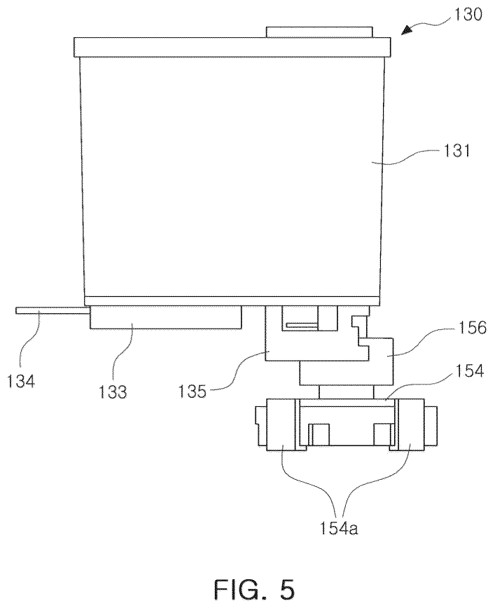

FIG. 4 is a perspective view of a cap module for attachment or detachment of a drum cap according to an example embodiment. FIG. 5 is a diagram illustrating a state in which a cap module is gripped by a gripper of an automated chemical drum replacement apparatus according to an example embodiment.

Referring to operation of the gripper 130, the drum cap 150 may be installed on the outlet of the chemical drum 10. As an example, the drum cap 150 may be mounted on the cap module 152 illustrated in FIG. 4, attached to and detached from the gripper 130, and thus may be attached to and detached from the chemical drum 10. The cap module 152 may include a fixing portion 154 gripped by the gripping fingers 135 of the gripper 130, and a coupling portion 156 rotatably installed on the fixing portion 154, the coupling portion 156 having a first coupling groove 156a coupled to the rotation shaft 136 of the gripper 130. The fixing portion 154 may include a plurality of wings 154a disposed to surround an outer circumferential surface of the drum cap 150. The plurality of wings 154a may be four wings, and may have an angle of about 90 degrees therebetween.

As illustrated in FIG. 5, when the gripping fingers 135 of the gripper 130 grip the coupling portion 156, the rotation shaft 136 (see FIG. 3) of the gripper 130 may be coupled to the first coupling groove 156a (see FIG. 4). Thereafter, when the rotation shaft 136 rotates, the drum cap 150 may rotate, and thus the drum cap 150 may be attached to or detached from the outlet of the chemical drum 10. When the drum cap 150 is separated, a phase of the wings 154a provided in the cap module 152 may be adjusted to prevent the drum cap 150 from falling off.

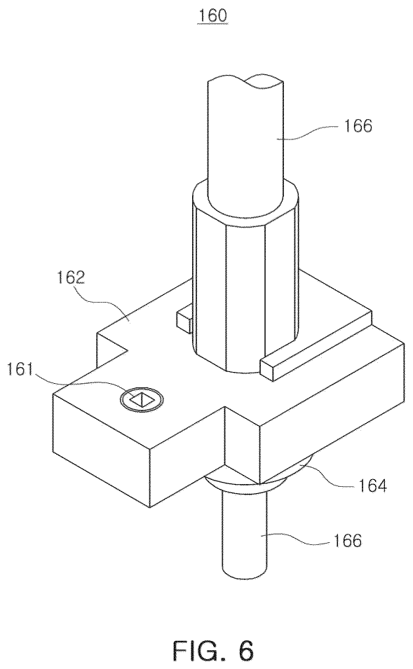

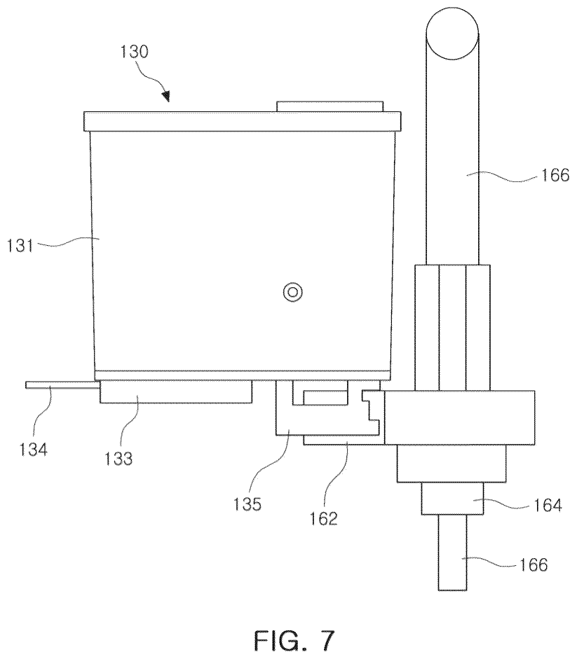

FIG. 6 is a perspective view of a coupler module installed on a chemical drum according to an example embodiment. FIG. 7 is a diagram illustrating a state in which a coupler module is gripped by a gripper of an automated chemical drum replacement apparatus according to an example embodiment.

As illustrated in FIG. 6, the coupler module 160 may include a body 162 having a second coupling groove 161, a coupler fastening portion 164 extending from a lower surface of the body 162, and a coupler flow pipe 166 disposed to pass through the body 162 and the coupler fastening portion 164, the coupler flow pipe 166 in which chemicals flow. At least one gear, connected to the second coupling groove 161 and the coupler fastening portion 164, may be provided within the body 162.

In addition, as illustrated in FIG. 7, in a state in which the gripping fingers 135 of the gripper 130 grip the body 162, the rotation shaft 136 (see FIG. 3) of the gripper 130 may be coupled to the second coupling groove 161 (see FIG. 6). Thereafter, when the coupler fastening portion 164 rotates with rotation of the rotation shaft 136, the coupler module 160 may be attached to or detached from an outlet of the chemical drum 10.

Hereinafter, operation of the automated chemical drum replacement apparatus 100 will described in more detail with reference to FIGS. 1 to 7. The manufacturing execution system 50 may communicate with the MCS 60 (i.e., that manages drum logistics) to transmit a signal indicating that chemical supply has ended in a specific facility. In this case, the manufacturing execution system 50 may select the automated chemical drum replacement apparatus 100 to perform an operation of replacing the chemical drum 10 and provide instructions for the operation to the RCS 70. The manufacturing execution system 50 may determine, through the RCS 70, a chemical supply facility on which the operation of replacing the chemical drum 10 is to be performed, using a preconfigured algorithm, based on supply importance and supply frequency for each chemical supply apparatus 20.

When an operation instruction is transmitted to the automated chemical drum replacement apparatus 100, the automated robotic assembly 110 may move and the manipulator 120 may operate to sense a monitor 24 of the chemical supply apparatus 20 through the vision camera 132. Thereafter, the monitor 24 may be operated through the gripping fingers 135 of the gripper 130 to switch a mode of the chemical supply apparatus 20 to an operation mode required for replacing the chemical drum 10. Thereafter, a marker installed on the chemical supply apparatus 20 may be recognized through the vision camera 132 to align the automated robotic assembly 110 to be in a correction position thereof. When the door 22 of the chemical supply apparatus 20 is opened, the operation of replacing the chemical drum 10 may be performed immediately. When the door 22 of the chemical supply apparatus 20 is closed, the vision camera 132 may sense a handle of the door 22 of the chemical supply apparatus 20. Thereafter, the door 22 of the chemical supply apparatus 20 may be opened through the door finger 134 of the gripper 130.

Thereafter, the automated robotic assembly 110 may separate the coupler module 160 from the chemical drum 10 in which chemicals have been used in the chemical supply apparatus 20. In this case, a position and a phase of the coupler module 160, fastened to the outlet of the chemical drum 10, may be identified through the vision camera 132, and then the coupler module 160 may be gripped through the gripping fingers 135 of the gripper 130. Accordingly, the rotation shaft 136 of the gripper 130 may be coupled to the second coupling groove 161. Thereafter, when the coupler fastening portion 164 rotates with rotation of the rotation shaft 136, the coupler module 160 may be separated from the outlet of the chemical drum 10. The separated coupler module 160 may be moved to a coupler storage box of the chemical supply apparatus 20 and fastened to the coupler storage box. Thereafter, the gripping fingers 135 may be separated from the coupler module 160.

Thereafter, the gripping fingers 135 of the gripper 130 may grip the cap module 152 stored in the travelling module 115, for example. Thereafter, the drum cap 150 stored in the coupler storage box may be identified through the vision camera 132, and the cap module 152 may be aligned with an upper surface of the drum cap 150. In addition, the drum cap 150 may be unscrewed and separated from the coupler storage box, using the rotation shaft 136 of the gripper 130. Thereafter, a phase of the fixing portion 154 of the cap module 152 may be adjusted to prevent the drum cap 150 from falling off. Thereafter, the drum cap 150, fixed to the cap module 152, may be moved to the outlet of the chemical drum 10, and an exact position of the outlet may be identified through the vision camera 132. Thereafter, the drum cap 150 may be fastened to the outlet by lowering the cap module 152 and rotating the drum cap 150 in a direction of fastening.

In this case, it may be identified whether the drum cap 150 is accurately fastened to the chemical drum 10 using a torque sensor and a position sensor of the manipulator 120, and whether the drum cap 150 is fastened to the chemical drum 10 with an appropriate torque.

Thereafter, chemical leakage liquids generated during the operation of replacing the chemical drum 10 may be detected through the vision camera 132, and a cleaning material or a cleaning material mounted on the coupler module 160 may be used to clean the chemical leakage liquids on the chemical drum 10.

Thereafter, the automated robotic assembly 110 may notify the manufacturing execution system 50 that the operation has been completed through the RCS 70. When the operation of the automated robotic assembly 110 is completed, the transfer robotic assembly 140 may transfer the empty chemical drum 10 to a logistics warehouse. In this case, the automated robotic assembly 110 may stand by until the transfer robotic assembly 140 brings a new chemical drum 10. If necessary, the automated robotic assembly 110 may close the door 22.

The transfer robotic assembly 140 may couple the hook portion 142a to the handle portion 32 of the cart 30 to transfer the cart 30. In addition, the handle portion 32 and the hook portion 142a may be attached to each other or detached from each other by raising and lowering the hook portion 142a.

Thereafter, the transfer robotic assembly 140 may transfer a new chemical drum 10 from the logistics warehouse to the chemical supply apparatus 20. In this case, the manufacturing execution system 50 may determine information about the chemical drum 10 stored in the logistics warehouse through a logistics management system. Thereafter, the automated robotic assembly 110 may move and the manipulator 120 may operate to sense the monitor 24 of the chemical supply apparatus 20 through the vision camera 132. Thereafter, the monitor 24 may be operated through the gripping fingers 135 of the gripper 130 to switch a mode of the chemical supply apparatus 20 to an operation mode required for replacing the chemical drum 10. Thereafter, when the door 22 of the chemical supply apparatus 20 is closed, the automated robotic assembly 110 may move and the manipulator 120 may operate, such that the vision camera 132 may sense a handle of the door 22 of the chemical supply apparatus 20. Thereafter, the door 22 of the chemical supply apparatus 20 may be opened through the door finger 134 of the gripper 130.

Thereafter, the new chemical drum 10 may be moved to an internal space of the chemical supply apparatus 20 by the transfer robotic assembly 140.

Thereafter, the automated robotic assembly 110 may move, and the manipulator 120 may operate such that the vision camera 132 of the gripper 130 senses the drum cap 150 installed on the chemical drum 10 and the outlet of the chemical drum 10. When the chemical drum 10 is introduced into the chemical supply apparatus 20 by the transfer robotic assembly 140, the vision camera 132 may recognize phase and position information of the drum cap 150 of the chemical drum 10. In addition, tilt information of the drum cap 150 may be recognized through a laser sensor to correct a degree of misalignment of the outlet of the chemical drum 10. In addition, the gripper 130 may accurately perform an operation of opening and closing the drum cap 150 using the sensed central position information and tilt angle information. In this regard, the vision camera 132 may primarily recognize an upper surface of the drum cap 150 when disposed on the drum cap 150. Thereafter, the vision camera 132 may be lowered to secondarily recognize precise position and tilt angle information of the drum cap 150. Thereafter, a degree of misalignment of the drum cap 150 may be recognized through a sensor provided in the manipulator 120, and the degree of misalignment of the drum cap 150 may be corrected during a fastening/separation operation.

Thereafter, a position and a phase of the cap module 152 stored in the travelling module 115 may be identified through the vision camera 132, and then the cap module 152 may be gripped through the gripping fingers 135. Thereafter, the manipulator 120 moves the gripper 130 to a position of the drum cap 150 and rotates the rotation shaft 136 of the gripper 130 to allow a phase of the drum cap to correspond to the phase of the cap module 152. Thereafter, the gripper 130 may be lowered such that the cap module 152 surrounds the drum cap 150, and the rotation shaft 136 may rotate to separate the drum cap 150 from the chemical drum 10. During separation, the gripper 130 may also rise to a height the same as a height to which the drum cap 150 rises. Thereafter, the manipulator 120 may operate such that the vision camera 132 of the gripper 130 senses the coupler storage box of the chemical supply apparatus 20. Thereafter, the drum cap 150 may be fastened to be stored in the coupler storage box. Thereafter, the cap module 152 may be stored in the travelling module 115.

Thereafter, a final position of the outlet of the chemical drum 10 may be identified through the vision camera 132, and a key code may be identified. In order to prevent an incorrect chemical material from being supplied to the chemical supply apparatus 20, the chemical drum 10 and the coupler module 160 may have unique key code information. As an example, the outlet of the chemical drum 10 and the coupler module 160 may have a key code having an engraved/embossed shape. Accordingly, before the coupler module 160 is mounted on the outlet of the chemical drum 10, key code information of each of the chemical drum 10 and the coupler module 160 may be sensed through the vision camera 132, such that the chemical drum 10 and the coupler module 160, corresponding to each other, may be coupled to each other.

Thereafter, the gripping fingers 135 of the gripper 130 may grip the coupler module 160. In this case, the coupler module 160 may be gripped by recognizing an upper surface of the coupler module 160 through the vision camera 132, correcting a position of the coupler module 160, and correcting a phase of the rotation shaft 136 such that the rotation shaft 136 is coupled to the second coupling groove 161. Thereafter, in a state in which the coupler module 160 is gripped, the coupler module 160 may be moved to a position of the outlet of the chemical drum 10. The rotation shaft 126 may rotate based on the previously obtained key code information to align key codes of the chemical drum 10 and the coupler module 160, and then the coupler module 160 may be installed on the outlet of the chemical drum 10. As an example, whether the coupler module 160 is securely fastened to the outlet may be recognized using a fastening torque and a position of the coupler module 160.

Thereafter, chemical leakage liquids generated during the operation of replacing the chemical drum 10 may be detected through the vision camera 132, and a cleaning material or a cleaning material mounted on the coupler module 160 may be used to clean the chemical leakage liquids on the chemical drum 10.

Thereafter, the door 22 may be closed by the automated robotic assembly 110.

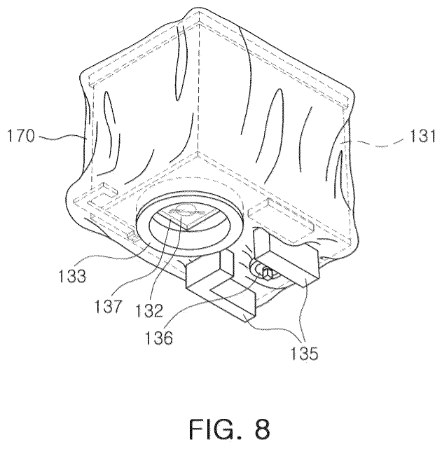

FIG. 8 is a diagram illustrating a state in which a first protective member is installed on a gripper of an automated chemical drum replacement apparatus according to an example embodiment.

As illustrated in FIG. 8, a first protective member 170 may be installed on the gripper 130. The first protective member 170 may serve to prevent chemical leakage liquids from getting onto the gripper 130. As an example, the first protective member 170 may be formed of a chemical-resistant fabric. The first protective member 170 may be installed on the gripper 130 to surround the entire gripper 130 except for the gripping fingers 135 of the gripper 130.

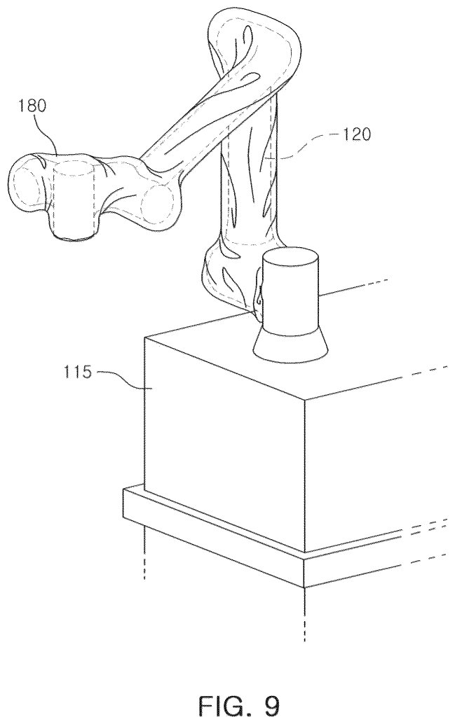

FIG. 9 is a diagram illustrating a state in which a second protective member is installed on a manipulator of an automated chemical drum replacement apparatus according to an example embodiment.

As illustrated in FIG. 9, a second protective member 180 may be installed on the manipulator 120. The second protective member 180 may serve to prevent chemical leakage liquids from getting onto the manipulator 120. As an example, the second protective member 180 may be formed of a chemical-resistant fabric. The second protective member 180 may be disposed to surround the entire manipulator 120.

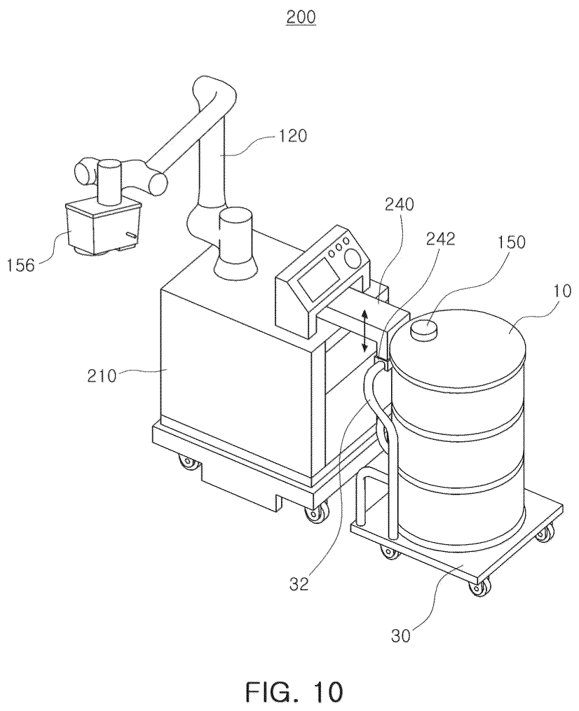

FIG. 10 is a perspective view of an automated chemical drum replacement apparatus according to an example embodiment.

Referring to FIG. 10, an automated chemical drum replacement apparatus 200 according to an example embodiment may include a travelling module 210, a manipulator 120, a gripper 130, and a connection module 240.

The manipulator 120 and the gripper 130 may be substantially the same as the components described above and repeated descriptions may be omitted.

The travelling module 210 may include a sensor to sense a surrounding environment and an obstacle by itself and a driver configured to enable automated travelling (i.e., enable automated movement of the automated robotic assembly 200). As an example, the travelling module 210 may be configured to move the automated chemical drum replacement apparatus 200 to transfer a chemical drum 10 (e.g., an empty/used chemical drum) to a logistics warehouse, and to transfer a new chemical drum 10 from the logistics warehouse to a chemical supply apparatus (e.g., the chemical supply apparatus 20). In addition, the travelling module 210 may be configured to move the automated chemical drum replacement apparatus 200 to a position allowing the gripper 130 to attach or detach a drum cap 150 and a coupler module 160 to each other or from each other.

The connection module 240 may be installed on the travelling module 210, and may serve to grip a handle portion 32 of a cart 30 on which the chemical drum 10 is loaded. Accordingly, the cart 30 may move together with the travelling module 210. To this end, the connection module 240 may include a hook portion 242 for gripping the handle portion 32. When the travelling module 210 moves the automated chemical drum replacement apparatus 200 after the hook portion 242 grips the handle portion 32, the cart 30 may move together with the travelling module 210. Accordingly, the chemical drum 10 loaded on the cart 30 may be transferred to the chemical supply apparatus 20 and the logistics warehouse. As the hook portion 242 is raised or lowered, the hook portion 242 may be attached to or detached from the handle portion 32 of the cart 30. To this end, a driver may be connected to the hook portion 242 to raise or lower the hook portion 242.

As described above, the travelling module 210 may include the manipulator 120 and the connection module 240. Thus, an operation of transferring the chemical drum 10 and attaching or detaching the drum cap 150 and the coupler module 160 to each other or from each other may be performed through a single travelling module 210.

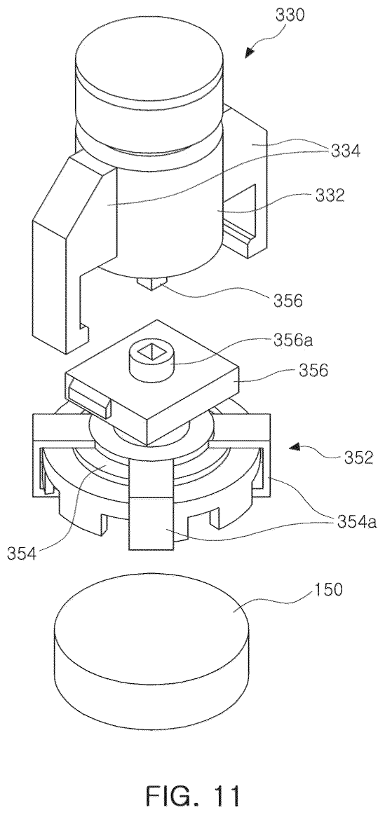

FIG. 11 is a diagram illustrating a gripper and a drum cap according to an example embodiment.

Referring to FIG. 11, a gripper 330 may include a body 332 having a cylindrical shape, a finger 334 disposed on a side surface of the body 332, and a rotation shaft 336 disposed to protrude from a lower surface of the body 332. A drum cap 150 may be mounted on a cap module 352, attached to or detachable from the gripper 330, and thus may be attached to or detached from the chemical drum 10. The cap module 352 may include a fixing portion 354 gripped by the finger 334 of the gripper 330, and a coupling portion 356 rotatably installed on the fixing portion 354, the coupling portion 356 having a first coupling groove 356a to which the rotation shaft 336 of the gripper 330 is coupled. The fixing portion 354 may include a plurality of wings 354a disposed to surround an outer circumferential surface of the drum cap 150. The wings 354a may prevent the drum cap 350 from falling off by adjusting a phase of the cap module 352 when the drum cap 150 is gripped. In a state in which the fingers 334 of the gripper 330 grip the coupling portion 356 of the cap module 352, the rotation shaft 336 of the gripper 330 may be coupled to the first coupling groove 356a. Thereafter, when the rotation shaft 336 rotates, the drum cap 150 may rotate and the drum cap 150 may be separated from an outlet of the chemical drum 10 (see FIG. 1).

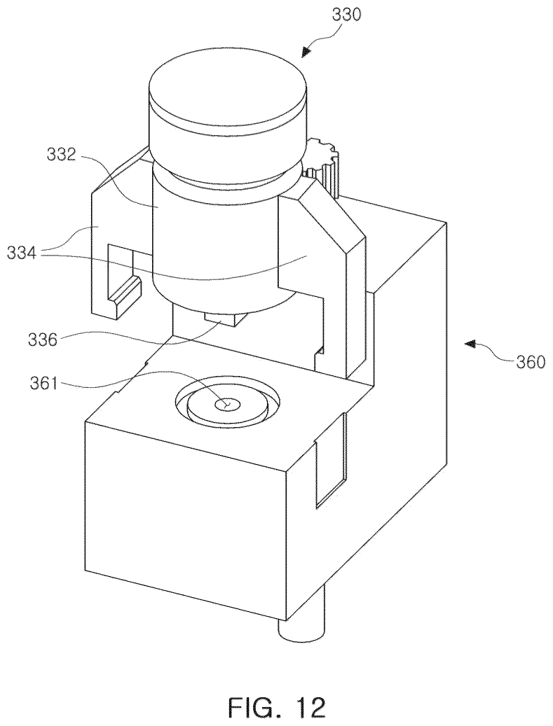

FIG. 12 is a diagram illustrating a gripper and a coupler module according to an example embodiment.

Referring to FIG. 12, a gripper 330 may include a body 332 having a cylindrical shape, fingers 334 disposed on a side surface of the body 332, and a rotation shaft 336 disposed to protrude from a lower surface of the body 332. The coupler module 360 may have a second coupling groove 361. The coupler module 360 may have a shape with a step. In addition, a plurality of gears may be provided below a region in which the second coupling groove 361 is disposed. For example, when the rotation shaft 336 rotates in a state of being coupled to the second coupling groove 361, the plurality of gears may rotate by the rotation shaft 336 to align key codes of a chemical drum 10 (see FIG. 1) and the coupler module 360. The coupler module 360 may be attached to or detached from an outlet of the chemical drum 10.

According to example embodiments of the present disclosure, there may be provided an automated chemical drum replacement apparatus capable of performing an operation of transferring and replacing a chemical drum without an operator, and a chemical drum conveyance and replacement system using the same.

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

1. A chemical drum replacement apparatus, comprising:
an automated robotic assembly configured to attach or detach a drum cap and a coupler module to or from a chemical drum; and
a transfer robotic assembly configured to transfer the chemical drum;
wherein the automated robotic assembly comprises:
a travelling module configured to move the automated robotic assembly;
a manipulator on an upper surface of the travelling module; and
a gripper at an end of the manipulator, the gripper configured to attach or detach the drum cap and the coupler module to or from the chemical drum.

2. The chemical drum replacement apparatus of claim 1, wherein the gripper comprises:
a gripper body connected to the manipulator;
gripping fingers on a lower surface of the gripper body; and
a rotation shaft between the gripping fingers.

3. The chemical drum replacement apparatus of claim 2, further comprising:
an output shaft on the gripper body;
wherein the rotation shaft protrudes from the output shaft; and
wherein the output shaft and the body form a labyrinth seal.

4. The chemical drum replacement apparatus of claim 2, wherein the gripper further comprises a vision camera on the lower surface of the gripper body and adjacent to the gripping fingers.

5. The chemical drum replacement apparatus of claim 4, wherein the gripper further comprises a transparent window configured to protect the vision camera from damage due to exposure to the chemical drum.

6. The chemical drum replacement apparatus of claim 4, wherein the gripper further comprises a vision light at least partially surrounding the vision camera.

7. The chemical drum replacement apparatus of claim 6, wherein the gripping fingers comprise a door finger configured to open and close a door, the door finger being adjacent to one side of the vision light.

8. The chemical drum replacement apparatus of claim 2, further comprising:
a cap module configured to be gripped by the gripping fingers when the drum cap is attached to or detached from the chemical drum.

9. The chemical drum replacement apparatus of claim 8, wherein the cap module comprises:
a fixing portion configured to be gripped by the gripper; and
a rotatable coupling portion on the fixing portion, and
wherein the rotatable coupling portion comprises a first coupling groove to which the rotation shaft is coupled.

10. The chemical drum replacement apparatus of claim 9, wherein the fixing portion comprises a plurality of wings at least partially surrounding an outer circumferential surface of the drum cap.

11. The chemical drum replacement apparatus of claim 2, wherein the coupler module comprises:
a coupler module body having a second coupling groove;
a coupler fastening portion extending from a lower surface of the coupler module body; and
a coupler flow pipe passing through the coupler module body and the coupler fastening portion.

12. The chemical drum replacement apparatus of claim 11, wherein the rotation shaft is coupled to the second coupling groove when the gripping fingers grip the coupler module body.

13. The chemical drum replacement apparatus of claim 2, wherein the gripper further comprises a first protective member in which the gripping fingers are externally exposed, the first protective member at least partially surrounding the gripper body, and
wherein the first protective member comprises a chemical-resistant fabric.

14. The chemical drum replacement apparatus of claim 1, wherein the manipulator is configured to operate with six degrees of freedom.

15. The chemical drum replacement apparatus of claim 1, wherein the transfer robotic assembly comprises a hook portion coupled to a handle portion, and
wherein the handle portion is provided in a cart on which the chemical drum is loaded.

16. The chemical drum replacement apparatus of claim 1, further comprising:
a second protective member at least partially surrounding the manipulator,
wherein the second protective member comprises a chemical-resistant fabric.

17. A chemical drum conveyance and replacement system comprising:
at least one chemical drum replacement apparatus comprising:
an automated robotic assembly configured to attach or detach a drum cap and a coupler module to or from a chemical drum; and
a transfer robotic assembly configured to transfer the chemical drum; and
a manufacturing execution system connected to the at least one chemical drum replacement apparatus,
wherein the automated robotic assembly comprises:
a travelling module configured to move the automated robotic assembly;
a manipulator on an upper surface of the travelling module; and
a gripper at an end of the manipulator, the gripper configured to attach and detach the drum cap and the coupler module to or from the chemical drum.

18. The chemical drum conveyance and replacement system of claim 17, wherein the manufacturing execution system comprises:
a manufacturing control system (MCS) configured to monitor a state of a chemical supply apparatus; and
a robot control system (RCS) configured to:
select one of the at least one chemical drum replacement apparatus to perform a chemical drum replacement operation; and
provide instructions to perform the chemical drum replacement operation.

19. The chemical drum conveyance and replacement system of claim 18, wherein the MCS is further configured to manage replacement and conveyance of a drum.

20. The chemical drum conveyance and replacement system of claim 18, wherein the RCS is further configured to provide instructions to perform the chemical drum replacement operation based on at least one of supply importance and supply frequency.

21. (canceled)
